(19) United States
(12) Patent Application Publication
(10) Pub. No.: US 2008/0276591 A1
(43) Pub. Date: Nov. 13, 2008

(54) Draper belt rib apparatus and method

(75) Inventors: Steve Tippery, Gretna, NE (US); Jens O. Petersen, Omaha, NE (US)

Correspondence Address: HUSCH BLACKWELL SANDERS LLP, 190 CARONDELET PLAZA, SUITE 600, ST. LOUIS, MO, 63105-3441, US

(73) Assignee: CLAAS Omaha, Inc., Omaha, NE (US)

(21) Appl. No.: 11/800,677

(22) Filed: May 7, 2007

(51) Int. Cl. A01D 57/06; A01D 41/06

(52) U.S. Cl. 56/181

(57) ABSTRACT

A draper belt rib comprising an outer portion being comprised of a material having a higher wear resistance than a base portion of the rib. The head has at least one surface disposed for exposure to wear surfaces. The head has a longitudinally extending projection that is formed with the wear surface of the outer portion and has a plurality of through holes in it longitudinally spaced along its length. The base portion is a material readily adherable to a flexible conveyer belt material. The base portion extends along either side of the longitudinally extending projection of the outer portion being formed such that a first lateral side of the base portion connects with an opposing lateral side of the base portion material through the through holes in the longitudinally extending projection of the outer portion. The connection comprises a retention bridge retaining the outer portion against the base portion.

### BACKGROUND OF THE INVENTION

1. Field of the Invention

The present invention is in the field of conveyor belts for agricultural equipment, particularly combine and harvester header draper belts.

2. Related Art

Combine and harvester headers that convey crop using conveyor belts are known. These headers, commonly known as “draper” headers to those of skill in the art, use a generally horizontal conveyor belt that is oriented substantially perpendicular to the direction of travel of the combine. They are supported by a frame and driven by drive rollers. The belt is directly behind the leading edge of the header, which includes a cutter. A reel causes the cut crop to fall onto the conveyer belt, which then conveys the cut crop towards the center of the header, where it is fed into a feeder house for threshing inside the combine.

Also known in the prior art is the placement of short vertical ribs periodically spaced along the length of the belt, which serve to more aggressively feed the crops towards the feeder house. Since typical belts for draper headers are made of vulcanized rubber, prior art ribs were also typically made of vulcanized rubber and attached to the outer belt surface with a vulcanization process.

Because the belt is a continuous loop, after the top surface of the belt has delivered crops to the center of the header, it turns under a roller to become a bottom surface of the belt, where it is transported laterally outwards until it can turn again around a lateral end roller and begin to convey new cut crop on top of the conveyor. The under side of the draper belt assembly includes bottom frame guides, such as indicated as reference no. 22 in FIG. 2. These frame guides are necessary to protect the belt and its ribs from moving contact with the other parts of the header, to promote proper tracking of the belt and to otherwise keep debris out of the moving portions of the belt.

In certain circumstances, the outer ridge of the belt ribs may come into contact with the frame guides. When this occurs, undesirably rapid wear of the belt ribs occurs. One of the circumstances that causes the undesirable contact between the top of the belt ribs and the frame guides is the belt sagging.

Draper belts are frequently equipped with tensioners that are capable of ameliorating belt sag. However, in response to a constantly increasing demand for speed and a greater capacity in the harvesting of crops in general, headers are becoming wider and the conveyer belts on them are consequently becoming longer. Longer conveyer belts sag more and, when long enough, overcome the capacity of tensioning systems to prevent contact of the ribs with the frame guides underneath them. For a variety of design considerations, increasing the tolerance between the frame guides and the belt ribs is also undesirable.

Accordingly, there is a need in the art to reduce the amount of wear caused to belt ribs by frame guides and other draper belt support components. Moreover, there is a constant need in the art to improve the durability of draper belts and their constituent parts in general.

Previous attempts to address this problem have been to use a different material for the ribs than the vulcanized rubber from which the rest of the belt is made. However, as is well known to those of skill in the arts of manufacturing and using belts made of such materials, vulcanized rubber does not adhere well to the type of materials that adequately resist the type of wear draper belt ribs are subjected to. Specifically, ultra high molecular weight polymers (UHMW polymers) would be desirable to use for at least the top portion of draper belt ribs because of their advantageous resistance to wear caused by contact with support components such as frame guides. Other prior art solutions such as using a fiberglass rod that may be inserted into a hole in the vulcanized rib or glued to the outer aspect of the rib are inadequate for insufficient rigidity, support or adhesion or for being constructed inside a vulcanized rubber top surface of the rib, which is then itself subject to wear.

Accordingly, there is a need in the art for a draper conveyer belt rib for a combine or harvester having a wear resistant, rigid, outer edge that remains durably attached to a lower rib portion that can be attached to a vulcanized rubber belt by traditional vulcanization adherence techniques that allow the rib to adequately bend while traveling around the roller.

### SUMMARY OF THE INVENTION

The present invention is a draper belt rib having a wear resistant upper aspect and a non-wear resistant lower aspect suitable for durable adherence to an outer surface of a draper conveyer belt. The upper, wear resistant portion of the rib has a longitudinally extending projection that is thinner in cross section than the overall rib. Longitudinally spaced along the projection is a plurality of through holes. A low wear resistant material forms the base of the rib and has a cross section width greater than the projection of the high wear resistant material. The base material extends through each of the through holes in the projection of the high wear resistance material, thus durably securing the upper and lower components of the rib.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a draper conveyor belt.

FIG. 2 is an end view of a draper conveyer belt.

FIG. 3 is an isolated perspective view of a wear resistant portion of a rib according to the present invention.

FIG. 4 is a perspective view of an assembled rib having a wear resistant upper aspect and a vulcanized rubber base.

FIG. 5 is a close up cutaway view of a draper belt rib vulcanized to a belt.

FIG. 6 is an end cutaway view of a draper belt rib.

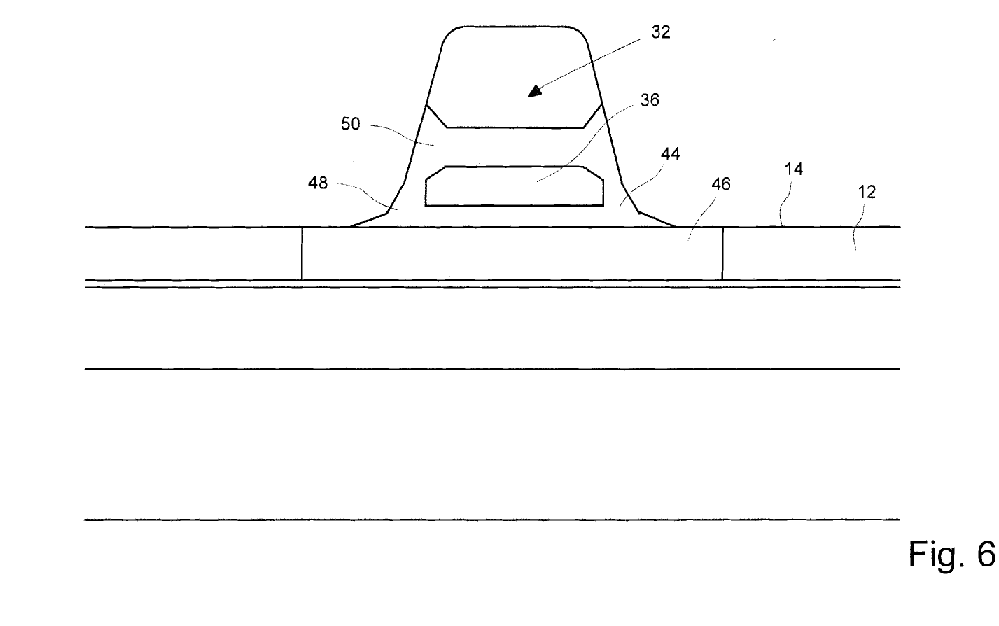

### DETAILED DESCRIPTION OF THE PREFERRED EMBODIMENTS

The following description of the preferred embodiment(s) is merely exemplary in nature and is in no way intended to limit the invention, its application, or uses.

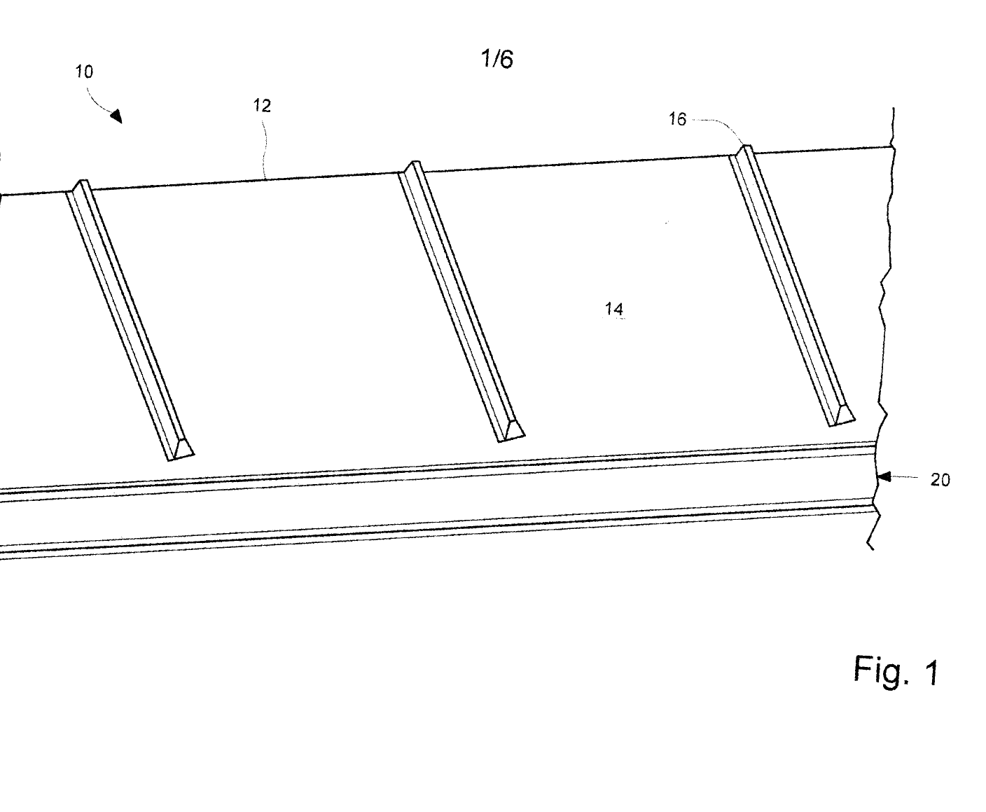

Referring now to the drawings in which like reference numbers indicate like elements, FIG. 1 is a perspective view of a draper conveyer belt 10. It includes a belt portion 12 having an outer surface 14. The belts are made of flexible material, commonly vulcanized rubber. Periodically spaced along the top surface 14 of belt 12 are ribs 16. In a combine draper header application, ribs 16 assist to convey cut crop laying on top surface 14 of the belt 12 towards a feeder house for continued processing.

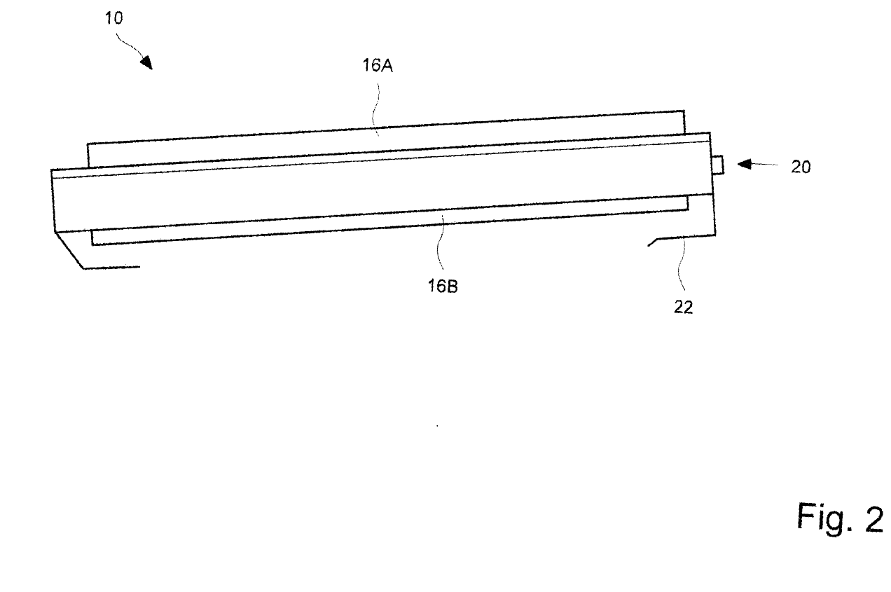

As seen in FIG. 2, the belt is supported by a belt support assembly 20. In a known manner, the ends of the belt 12 are supported by rollers. Typically, at least one of the rollers is a drive roller and the continuous loop belt 12 rolls around two end rollers and is supported in between by supports which may be comprised of guide surfaces or other rollers (not shown). Because it is a continuous loop, each rib 16 will make a circular path around the belt frame assembly and around two rollers 20 so that it may serve its useful purpose on the top surface indicated at 16(a) in FIG. 2 and then return laterally outwards on the underside of the assembly, indicated at 16(b) in FIG. 2.

The draper belt and other components are supported in a known fashion by an overall frame header. In order that the belt 12 and ribs 16 are not damaged in their return path on the underside of the draper conveyer, frame guides 22 are provided. Frame guides further help maintain proper tracking of the belt 12 and protect it from debris entering between it and its support assembly 20. As can be seen in FIG. 2, there is a gap built in between frame guide 22 and outermost edge of the rib 16. However, as described above, these two surfaces often come in contact disadvantageously despite this tolerance, causing wear to the outermost edge of the belts 16.

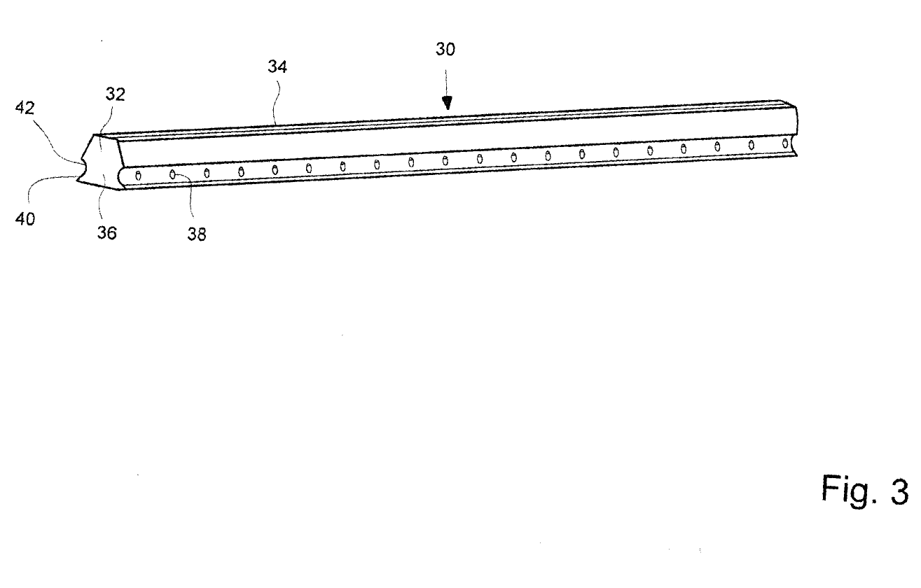

Each individual rib of the present invention has a wear resistant portion 30 and a base portion 40. As seen in FIG. 3, the wear resistant portion 30 has a head 32, which includes an outermost surface 34. Outermost surface 34 and, optionally, other faces of head 32 are designed to be exposed and positioned in assembly such that outermost surface 34 will be the surface that contacts other components of the draper belt support assembly 20, including the frame guide 22 and any other components of the header. The outer portion 30 of the rib is made of a material that is more wear resistant than a base portion described below. In the depicted embodiment, the outer portion 30 is made of ultra high molecular weight polymers.

Underneath head 32 and extending longitudinally for the length of the rib outer portion 30 is a central projection 36. In the depicted embodiment, central projection 36 supports head portion 32 and is integrally formed with it (by extrusion). In the depicted embodiment, the projection 36 is longitudinally continuous. In the depicted embodiment, longitudinally spaced along projection 36 are through holes 38, which, as depicted, are generally lateral to rib 16 or the longitudinal axis of outer portion 30. In the depicted embodiment, projection 36 has on its lowermost or innermost aspect flanges 40, thereby defining a longitudinally extending neck 42 between head 32 and flanges 40. In the depicted embodiment, through holes 38 extend through neck 42.

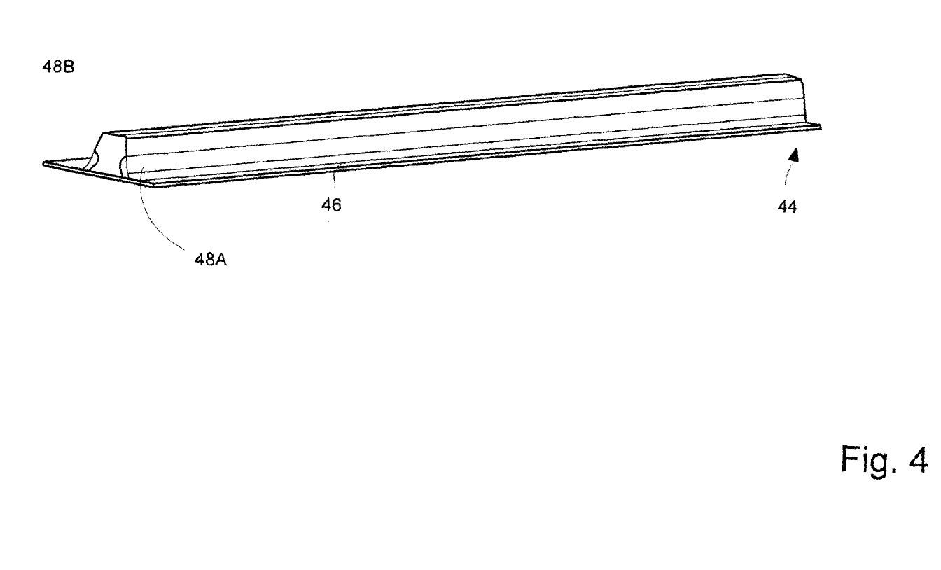

As best seen in FIG. 4, each rib 16 of the present invention further includes a base portion 44. The base portion is made of a material that may be readily adhered to the top surface 14 of the belt 12. In the depicted embodiment, the base portion 44 is comprised of vulcanized rubber. Base portion 44 has two lateral sides 48A and 48B. These sides include inner faces that are convex inwards to fit the concave sides of the neck 42 in the upper portion in a retaining engagement. Optionally, a further base portion support 46 may be positioned intermediate to the base portion and the top surface 14 of the belt 12. In the depicted embodiment, it would be the undersurface of intermediate portion 46 that would be adhered to the top surface 14 of the belt 12 by vulcanization.

Base portion 44 is formed around the central projection 36 of outer portion 30. The base portion 44 material fills the neck 42 of the outer portion 30. In the depicted embodiment, the outer edges of the rib slant outwards from the upper aspect to form a trapezoidal cross section, although other cross sectional configurations are within the scope of the present invention.

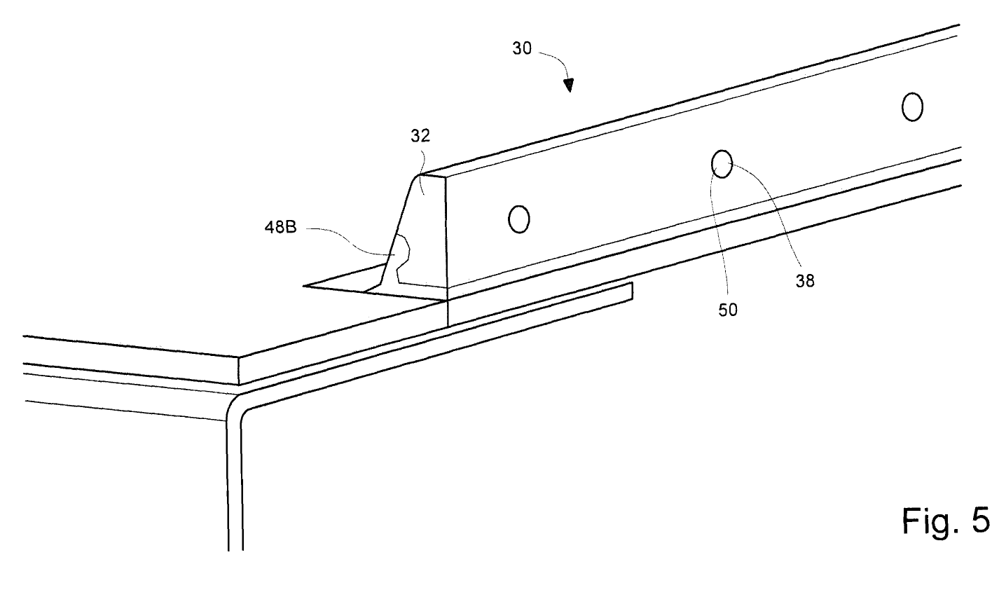

As best seen in cutaway perspective view FIG. 5 and cross section 7, a retention bridge or loop 50 extends through holes 38 such that the upper portion is held in position relative to base portion 44. In the depicted embodiment, the material of the base portion 44 extends through the throughholes 38 to form a continuous integrally formed bridge 50 between the two sides of base portion 44. The continuous, integrally formed loop 50 structure of the base portion 44 through holes 38 forms a retention structure sufficient to retain the outer portion 30 in its preconfigured position regardless of the strength, weakness or even absence of adhesion between the surfaces of the base portion 44 and the outer portion 30.

Base portion 44 is further attached to intermediate portion 46 by known methods such as vulcanization and, in turn, intermediate portion 46 may be attached to a top surface 14 at belt 12. Optionally, intermediate portion 46 may be attached into a recess 48 provided for and dimensioned to receive it.

In manufacturing, a wear resistant plastic, such as a UHMW polymer, is extruded longitudinally to have at least an upper head 32 and a longitudinally extending projection 36. Thereafter, through holes 38 are fabricated in the longitudinally extending projection 36, as by drilling or punching. Next, a material that is flowable at an elevated temperature, such as rubber, is used to form a base portion 44. The forming of base portion 44 includes the flow of the base portion material through the through holes 38, as for example placing the upper portion 30 at the bottom of a mold and pouring molten rubber on top of the mold so that the rubber flows around projection 36. In curing or otherwise, hardening of the flowable material of the base portion will include hardening within the through holes 38 of the upper portion, thereby forming the continuous, integrally formed loop or retention bridge 50 for structurally retaining the upper portion 30. Thereafter, a bottom surface of the base portion 44 is adhered to an intermediate portion 46 or belt 12 by known techniques such as vulcanization. Optionally, adherent material such as glue may be placed on those surfaces of the upper portion, for example the longitudinally extending portion 36, to further promote the fabrication of a unified rib.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A conveyor belt rib for a combine or harvester comprising:
an outer portion having a wear surface, said outer portion being made of a material more wear resistant than a base portion of said rib;
a base portion, said base portion being configured to retain said outer portion on an outer aspect of said base portion and said base portion being configured to adhere to an outer surface of a conveyor belt on an inner aspect of said base portion; and
said base portion being comprised of a material more adherent to said conveyor belt than said outer portion of said rib.

2. The conveyor belt rib of claim 1 wherein
said outer portion has a projection defining a neck and said base portion has a groove, whereby said groove of said base portion retaining said outer portion.

3. The conveyor belt rib of claim 1 wherein said outer portion includes throughholes and said base portion includes retention bridges through said throughholes of said outer portion, said retention bridges retaining said outer portion to said base portion.

4. The conveyor belt rib of claim 1 wherein said outer portion is an ultra high molecular weight plastic.

5. The conveyor belt rib of claim 1 wherein said base portion is rubber.

6. A draper belt rib for a combine or harvester comprising:
an outer portion having a wear surface, said outer portion having a projection substantially opposed to said wear surface, said projection having laterally opposed, longitudinally extending concavities, said concavities defining a neck in said projection, said neck being between said wear surface and a flange on said projection;
said outer portion being made of a material more wear resistant than a base portion of said rib;
said base portion having two lateral opposed, longitudinally extending sides, each of said sides having an internally oriented convexity, said convexities being fitted to said concavities of said neck of said outer portion such that said base portion sides retain said upper portion; and
said base portion being made of a material more adherent to a draper belt surface than said upper portion.

7. The draper belt rib of claim 6 further comprising throughholes, said throughholes being longitudinally spaced along said neck of said outer portion and said base portion extending through said throughholes to form a retaining bridge between said lateral sides of said base portion through said throughholes.

8. The rib of claim 6 wherein said outer portion is ultra-high molecular weight plastic.

9. The rib of claim 6 wherein said base portion is rubber.

10. A draper belt rib comprising:
an outer portion, said outer portion being comprised of a material having a higher wear resistance than a base portion of said rib, and said outer portion having a head with at least one surface disposed for exposure to wear surfaces;
said outer portion having a longitudinally extending projection, said longitudinally extending projection being integrally formed with the wear surface of the outer portion and said longitudinally extending projection having a plurality of through holes in it, said through holes being longitudinally spaced along said longitudinally extending projection; and said through holes being oriented laterally to said longitudinally extending projection;
said base portion being a material readily adherable to a flexible conveyer belt material and said base portion extending along either side of said longitudinally extending projection of said outer portion and said base portion being formed such that a first lateral side of said base portion connects with an opposing lateral side of said base portion material through said through holes of said longitudinally extending projection of said outer portion, said connection comprising a retention bridge retaining said outer portion against said base portion.

11. The method of claim 10 wherein said outer portion is ultra high molecular weight plastic.

12. The method of claim 10 wherein said base portion is vulcanized rubber.

13. The apparatus of claim 10 further comprising a belt having a plurality of said ribs attached to an outer surface of said belt.

14. The rib of claim 10 wherein said upper portion is extruded.

15. The rib of claim 10 wherein said throughholes are oriented laterally in relation to a longitudinal axis of said outer portion.

16. The rib of claim 10 wherein said throughholes are drilled or punched.
